(19) United States
(12) Patent Application Publication
(10) Pub. No.: US 2024/0271298 A1
(43) Pub. Date: Aug. 15, 2024

(54) ELECTROCATALYST SUPPORT MATERIAL

(71) Applicant: Robert Bosch GmbH, Stuttgart (DE)

(72) Inventors: Mordechai KORNBLUTH, Brighton, MA (US); Sarah STEWART, San Carlos, CA (US)

(21) Appl. No.: 18/162,306

(22) Filed: Jan. 31, 2023

(51) Int. Cl. C25B 11/067; C25B 1/02; C25B 11/097

(52) U.S. Cl. CPC C25B 11/067; C25B 1/02; C25B 11/097

(57) ABSTRACT

An electrolyzer catalyst support includes a material including one or more transparent conducting oxide (TCO) compositions of formula (I): AₓB_{y}Sb_{w}O_{z} (I), where A is a dopant and is a halogen, alkali metal, transition metal, or metalloid, B is Zn, Cd, Sn, or Ti, x is any number between about 0.0 and 0.2, y is any number between 0.9 and 2, w is 0 or 2, and z is any number between 0.9 and 3, when A is F and B is Sn, the oxide is non-stoichiometric.

### TECHNICAL FIELD

The present disclosure relates to an electrocatalyst support material including conductive oxides for membrane electrode assemblies (MEA) for hydrogen-generating devices, a method of identifying the same, and a method of producing and applying the same.

### BACKGROUND

Hydrogen technology such as fuel cells and electrolyzers are becoming increasingly popular due to their ability to produce clean energy. But cost of their individual components has remained to be a hurdle to large scale production. Due to the harsh environment of the fuel cells and electrolyzers, only a limited number of materials has been identified as suitable for production of their components such as electrodes and reaction catalysts. Most of the traditional materials include rare elements which are cost prohibitive.

### SUMMARY

In an embodiment, an electrolyzer catalyst support is disclosed. The support includes a material including one or more conducting oxide compositions of formula (I):

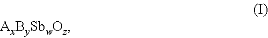

where
A is a dopant and is a halogen, alkali metal, transition metal, or metalloid,
B is Zn, Cd, Sn, or Ti,
x is any number between about 0.0 and 0.2,
y is any number between 0.9 and 2,
w is 0 or 2, and
z is any number between 0.9 and 3,
when A is F and B is Sn, the oxide is non-stoichiometric.

The catalyst support may be an anode electrocatalyst support. w may be 0 such that the material includes a binary conducting oxide. A may be F, Cl, Ta, or B. B may be Cd. At least one of the one or more conducting oxides of formula (I) may have an oxygen vacancy. The material may include CdSb₂O₃. The material may also include a conducting oxide having a formula (II):

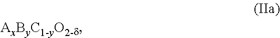

where
A is a halogen,
B is Sn or Zn,
C is Ti or Cd,
x is any number between 0.01 and 0.2,
y is any number between 0 and 1, and
δ is any number between 0 and 3 optionally including a fractional part denoting oxygen vacancies.

In another embodiment, an electrochemical cell electrode is disclosed. The cell electrode may include an electrocatalyst including Ir. Ru, or both, and an electrocatalyst support adhered to the electrocatalyst and including a material having one or more conducting oxide compositions of formula (I):

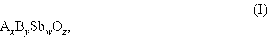

where
A is a dopant and is a halogen, alkali metal, transition metal, or metalloid,
B is Zn, Cd, or Ti,
x is any number between about 0.0 and 0.2,
y is any number between 0.9 and 2,
w is 0 or 2, and
z is any number between 0.9 and 3.

A may be a halogen. w may be 0. The material may include a ternary oxide and Sb is present. The electrochemical cell may be an electrolyzer. The electrocatalyst may have a formula IrₓNi₁₋ₓ, where 0≤x≤1. The material may also include a conducting oxide having a formula (II):

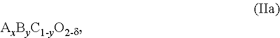

where
A is a halogen,
B is Sn or Zn,
C is Ti or Cd,
x is any number between 0.01 and 0.2,
y is any number between 0 and 1, and
δ is any number between 0 and 3 optionally including a fractional part denoting oxygen vacancies.

In yet another embodiment, an electrochemical cell component is disclosed. The component may have a bulk layer including metal and a surface layer including a conducting oxide material including one or more compositions of formula (I):

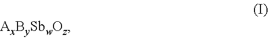

A is a dopant and is a halogen, alkali metal, transition metal, or metalloid,
B is Zn, Cd, Sn, or Ti,
x is any number between about 0.0 and 0.2,
y is any number between 0.9 and 2,
w is 0 or 2, and
z is any number between 0.9 and 3,
when A is F and B is Sn, w=0, z=2, and the composition further includes Ti_{1-y}.

The component may be an anode electrocatalyst support. The component may be a flow field plate. The conducting oxide material may include a binary zinc oxide. A may be Cl, Ta, or B.

### BRIEF DESCRIPTION OF THE DRAWINGS

FIG. 1 is a schematic depiction of a non-limiting example of proton-exchange membrane fuel cell (PEMFC) including a MEA;

FIG. 2 shows schematically principles of electrolysis in a MEA; and

FIG. 3 shows a plot of material reactivity screening with results for reactivity with hydrogen, water, in comparison to reactivity with Ni, and Ir, and cost of the materials.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Fuel cells, or electrochemical cells, that convert chemical energy of a fuel (e.g. H₂) and an oxidizing agent into electricity through a pair of electrochemical half (redox) reactions, have become an increasingly popular technology. Fuel cells are now a promising alternative transportation technology capable of operating without emissions of either toxins or green-house gases. One of the current limitations of wide-spread adoption of this clean and sustainable technology is related to clean production of H₂ fuel.

A proton-exchange membrane fuel cell (PEMFC) represents an environment friendly alternative to internal combustion engines for a variety of vehicles such as cars and buses. A PEMFC typically features a relatively high efficiency and power density. A very attractive feature of the PEMFC engine are no carbon emissions, provided that the hydrogen fuel has been gained in an environmentally friendly manner. Besides being a green engine, the PEMFC may be used in other applications such as stationary and portable power sources.

The PEMFC technology; however, presents a number of challenges connected to its maintenance, sustainable performance over time, longevity, and production cost. For example, the PEMFC has a highly corrosive environment requiring materials capable of withstanding the challenging conditions. While focus is on the overall performance of the fuel cells, incremental improvements of individual components of the PEMFC are needed.

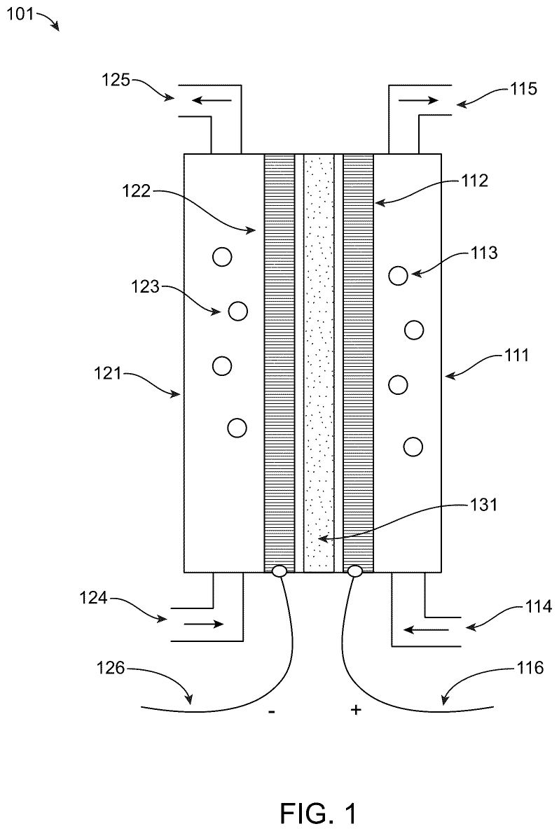

A non-limiting example of a PEMFC is depicted in FIG. 1. A core component of the PEMFC 10 that helps produce the electrochemical reaction needed to separate electrons is the Membrane Electrode Assembly (MEA) 12. The MEA 12 includes subcomponents such as electrodes (cathode, anode), catalysts, and polymer electrolyte membranes. Besides MEA 12, the PEMFC 10 typically includes other components such as current collectors 14, gas diffusion layer(s) 16, gaskets 18, and bipolar plate(s) 20.

Similarly, a proton-exchange membrane (PEM) electrolyzer stack may utilize MEA. In parallel opposite to a PEMFC is a PEM electrolyzer. Whereas the PEMFC consumes hydrogen and oxygen to create electricity and water, a PEM electrolyzer is an electrochemical device designed to convert electricity and water into hydrogen and oxygen. A PEMFC and a PEM electrolyzer may be used together to store energy via hydrogen. The PEM electrolyzer utilizes electrolysis for hydrogen production. The PEM electrolyzer may be utilized in applications including industrial, residential, and military applications and technologies focused on energy storage such as electrical grid stabilization from dynamic electrical sources including wind turbines, solar cells, or localized hydrogen production for industrial and other uses.

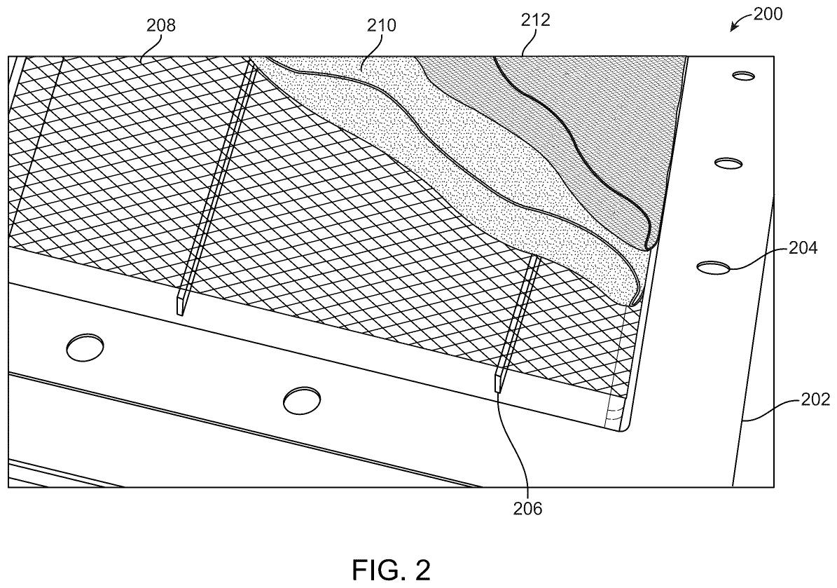

A depiction of the electrolysis principle, utilized by a PEM electrolyzer, with relevant reactions is depicted in FIG. 2. The electrolyzer 30 includes the PEM 32, anode 34, and cathode 36. During electrolysis, water is broken down into oxygen and hydrogen in anodic and cathodic electrically driven evolution reactions. The reactant liquid water (H₂O) permeates through the anode 34 porous transportation layer (PTL) to the anode catalyst layer, where the oxygen evolution reaction (OER) occurs. The protons (H⁺) travel via the PEM 32, and electrons (e−) conduct through an external circuit during the hydrogen evolution reaction (HER) at the cathode 36 catalyst layer. The anodic OER requires a much higher overpotential than the cathodic HER. It is the anodic OER which determines efficiency of the water splitting due to the sluggish nature of its four-electron transfer.

Different materials are used to produce the PEM electrolyzer 30. An example of the anode PTL layer material may be titanium (Ti) and the cathode PTL layer may be carbon-based materials such as carbon paper, carbon fleece, etc. The PEM 32, anode 34, and cathode 36 may be surrounded by flow field, bipolar or separator plates which may be made, for example, from Ti, or gold- or platinum-coated Ti metals.

Catalysts are typically used on the anode 34 and the cathode 36 to assist with the half-reaction processes. The typical catalyst material on the cathode 36 is platinum (Pt) while the typical catalyst used on the anode 34 is ruthenium (Ru), iridium (Ir), Ir—Ru, ruthenium oxide (RuO₂), iridium oxide (IrO₂), or iridium-ruthenium oxide (Ir—Ru—O) due to a combination of a relatively high activity and durability. But large-scale use and production of PEM electrolyzers requires substantial amount of the catalyst materials, which poses a problem for the industry. Out of all PEM electrolyzer components, the anode catalyst is the most expensive constituent due to use of the rare metals Ir and/or Ru, and lack of opportunity to reduce its cost through economies-of-scale effects.

At the anode 34, Ir typically catalyzes the OER (H₂O→2H⁺+½O2+2e⁻); and, at the cathode 36, Pt typically catalyzes the HER (2H⁺+2e⁻→H₂). The cell temperature typically ranges from 50 to 80° C. The cell voltage in the electrolyzer 30 is rather high compared to a fuel cell (greater than 1.23 V), typically ranging from 1.8 to 2.2 V vs. SHE at full load to split water into its constituent atoms. Due to high operating voltage, the electrolyzer 30 materials may undergo further catalyst degradation (e.g., metal dissolution that can lead to the loss in electrochemically active surface area), which may affect the entire electrolyzer 30 stack system throughout its lifetime.

There are typically two important design factors for selecting the PEM electrolyzer anode 34 catalyst: 1) catalytic activity and 2) catalyst stability or durability during high voltage operation. While noble metals such as Ir, Ru, or Pt are known to be relatively “immune” against corrosion compared to other materials, high voltage operation that oxidizes the surface of the metal may still trigger dissolution. For example, IrO₂ is actively used for PEM electrolyzer applications which can add value in terms of catalyst stability. Adding Ru (or another transition metal like Nb) to IrO₂ may increase the catalytic activity for the OER, when compared to pure IrO₂ catalyst. But Ru and the transition metal may leach out in the acidic environment with elevated voltage operation. This may lead to reduced electrochemical surface area (ECSA) loss and PEM electrolyzer degradation. Due to the dissolution of these expensive catalyst materials and high cost associated with their acquirement, a large-scale production is unsustainable, costly, and impracticable.

Additionally, the same electrolysis principles described above with respect to the PEM electrolyzer 30 apply to the PEMFC anode. When the fuel cell is operated under harsh operating conditions such as rapid load change or subzero start-up, fuel starvation may occur. Upon the fuel starvation at the anode, hydrogen is no longer sufficient to provide the needed protons and electrons so water electrolysis reaction and carbon corrosion may occur. The corrosion may deteriorate and compromise the anode materials. To prevent the degradation, an OER catalyst may be added to the anode to promote water electrolysis reaction over carbon corrosion.

Various support materials have been provided for the catalysts to increase the catalyst mechanical stability, prevent catalyst particle detachment, and/or reduce the catalyst particle mobility. Among the support materials, carbon, alumina, and silica have gained popularity, especially among the fuel cell support materials. But carbon cannot be used as a catalyst support in electrolyzers, especially on the anode because of the high operating temperatures. Further, many materials are not stable at voltages of oxygen evolution (>1.4V); for example, the carbon supports are oxidized in this voltage range.

Thus, a free-standing layer of catalyst is often used in PEM electrolyzers without a support which in turn limits the ability to reduce the catalyst loading in the membrane electrode assembly (MEA). Without a support, the catalyst is typically used in such quantity that a continuous layer of the catalyst is formed, which is impractical and costly. A stable catalyst support could allow for lower catalyst loadings and thus overall cost reduction.

Other materials besides carbon may not bind or demobilize the catalyst particle sufficiently such that detachment or leaching of the catalyst occurs. Alternatively or additionally, the materials may not be stable in an environment which is acidic or contains water. Yet other materials such as TiO₂ may have some have desirable properties but their use is impractical because of insufficient conductivity; applicability of TiO₂ thus requires a relatively high loading of the catalyst which is undesirable.

Given the expense of the precious metals such as Ir, there is a need to identify a stable catalyst support material for electrochemical cells, electrolyzers, and especially electrolyzer anode such that a minimum amount of the electrocatalyst may be used with maximum retention of the catalyst within the system.

In one or more embodiments, a material is disclosed. The material may include an electrochemical cell material, fuel cell material, electrolyzer material. The material may include a catalyst support material, an electrocatalyst support material. The material may be configured as a coating, a layer, a multi-layer. The material may be configured as a catalyst layer (CL). The CL may be a component of an electrochemical cell that catalyzes a chemical reaction. A non-limiting example chemical reaction may include splitting hydrogen: H₂→2H⁺+2e⁻. The cell may be an electrolytic cell that produces hydrogen from water. The cell may be a cell that contains a PEM to transport protons between the anode and cathode. The material may be structured as a flow field plate material such as a BPP material or material of a component utilized to guide gas or liquid flow in the cell.

The material may be included in a system as a catalyst support material where the electro/catalyst may include Pt, Ru, Ir-based material such as the catalyst materials named herein such as Ir, Ru, Ir—Ru, IrO₂, RuO₂, and/or Ir—Ru—O. The catalyst may include IrₓNi₁₋ₓ, where 0≤x≤1. The catalyst may include nanoparticles. The electrocatalyst may be an electrode electrocatalyst. The electrode may be an anode, cathode, or both of a MEA, PEM electrolyzer, or PEMFC.

The material may be an oxide material. The material may be a transparent conducting oxide (TCO). TCOs are electrically conductive materials with relatively low absorption of light. TCOs are doped metal oxides, typically used in optoelectronic devices. The material may have greater than about 80, 81, 82, 83, 84, or 85% transmittance in the visible part of the spectrum. The material may be a non-transparent conducting oxide. The material may have conductivity of at least 1 mS/cm to 1 S/cm.

The material may include a binary oxide, a ternary oxide, or both. The material may be doped. The material may include interstitial metal ions, oxygen vacancies, or both. The material may be free of interstitial metal ions, oxygen vacancies, or both. The material may include, comprise, consist essentially of, or consist of one or more compositions of formula (I):

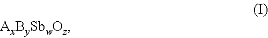

where
A is an alkali metal, alkaline earth metal, coinage metal, volatile metal, icoasagen, tetrel, pentel, chalcogen, halogen, transition metal, post-transition metal, metalloid, or nonmetal,
B is a volatile metal, tetrel, transition metal, or post-transition metal,
x is any number between about 0.0 and 0.2,
y is any number between 0.9 and 2,
w is 0 or 2, and
z is any number between 0.9 and 3.

The material may include, comprise, consist essentially of, or consist of one or more compositions of formula (I):

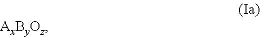

where
A is an alkali metal, alkaline earth metal, coinage metal, volatile metal, icoasagen, tetrel, pentel, chalcogen, halogen, transition metal, post-transition metal, metalloid, or nonmetal,
B is a volatile metal, tetrel, transition metal, or post-transition metal,
x is any number between about 0.0 and 0.2,
y is any number between 0.9 and 2, and
z is any number between 0.9 and 3.

The material may include a metal oxide having about 0-25 at. % oxygen vacancies compared to the stoichiometric ideals. The material may include, comprise, consist essentially of, or consist of one or more compositions, featuring an oxygen vacancy, of formula (I):

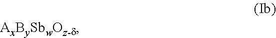

where
A is an alkali metal, alkaline earth metal, coinage metal, volatile metal, icoasagen, tetrel, pentel, chalcogen, halogen, transition metal, post-transition metal, metalloid, or nonmetal,
B is a volatile metal, tetrel, transition metal, or post-transition metal,
x is any number between about 0.0 and 0.2,
y is any number between 0.9 and 2,
w is 0 or 2,
z is any number between 0.9 and 3, and
δ is any number between 0 and 0.25, denoting the oxygen vacancies.

In formulas (I), (Ia), (Ib), A may be a dopant. A may be an element from Period 2 of the Periodic Table of Elements and may include Li, Be, B, C, N, F; Period 3 of the Periodic Table of Elements and may include Na, Mg, Al, Si, P, S, Cl; Period 4 of the Periodic Table of Elements and may include K, Ca, Ti, V, Cr, Mn, Fe, Co, Ni, Cu, Zn, Se, Br; Period 5 of the Periodic Table of Elements and may include Zr, Nb, Mo, Pd, Ag, Cd, Sn, Te, I; or Period 6 of the Periodic Table of Elements and may include Ba, Ta, W, Pt, Pb, Bi.

In formulas (I), (Ia), (Ib), A may be from Group IA, IIA, IIIA, IVA, VA, VIA, VIA, IB, IIB, NB, VB, VIB, VIIB, or VIIIB. In formulas (I), (Ia), (Ib), A may be an alkali metal, alkaline earth metal, coinage metal, volatile metal, icoasagen, tetrel, pentel, chalcogen, halogen, transition metal, post-transition metal, metalloid, or nonmetal. In a non-limiting example, A may be a halogen. In another non-limiting example, A may be a metalloid. In yet another non-limiting example, A may be a transition metal from Group VB.

In formulas (I), (Ia), (Ib), A may be an element selected from the group consisting of Ag, Al, Au, B, Ba, Be, Bi, Br, C, Ca, Cd, Cl, Co, Cr, Cu, F, Fe, I, K, Li, Mg, Mn, Mo, N, Na, Nb, Ni, P, Pb, Pt, S, Se, Si, Sn, Ta, Te, Ti, V, W, Zn, or Zr.

In formulas (I), (Ia), (Ib), B may be from Period 4 of the Periodic Table of Elements and may include Ti or Zn; or Period 5 of the Periodic Table of Elements and may include Cd or Sn. In formulas (I), (Ia), (Ib), B may be from Group NA, JIB, or NB. In formula (I), (Ia), (Ib), B may be a volatile metal, tetrel, transition metal, or post-transition metal. In formulas (I), (Ia), (Ib), B may be an element selected from the group consisting of Cd, Sn, Ti, or Zn.

In formulas (I), (Ia), (Ib), x may be any number between about 0.0 and 0.2. x may be about 0.00, 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.10, 0.105, 0.11, 0.115, 0.12, 0.125, 0.13, 0.135, 0.14, 0.145, 0.15, 0.155, 0.16, 0.165, 0.17, 0.175, 0.18, 0.185, 0.19, 0.195, or 0.20, or a range including any two of the disclosed numerals. A non-limiting example of the range may be about 0-0.2, 0.01-0.2, 0.03-0.09, or 0.05-0.075. x may be 0.01≤x<2, 0.01<x<0.2, 0.01<x<0.2, or 0.01<x≤0.2, or x may be 0.0≤x≤0.2.

In formulas (I), (Ia), (Ib), y may be any number between about 0.9 and 2. y may be about 0.9, 0.95, 1.0, 1.05, 1.10, 1.15, 1.2, 1.25, 1.3, 1.35, 1.4, 1.45, 1.5, 1.55, 1.6, 1.65, 1.7, 1.75, 1.8, 1.85, 1.9, 1.95, or 2.0, or a range including any two of the disclosed numerals. A non-limiting example of the range for y may be about 0.9-2.0, 1.0-1.8, or 1.2-1.7. y may be 0.9≤y≤2.0, 0.9<y<2.0, 0.9≤y<2.0, or 0.9<y≤2.0.

In formulas (I), (Ib), w is 0 or 2. w indicates presence of Sb, antimony. When w is 0, Sb is absent, when w is 2, Sb is present and z may be 3.

In formulas (I), (Ia), (Ib), z may be any number between about 0.9 and 3. z may be about 0.9, 0.95, 1.0, 1.05, 1.11, 1.115, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, or 3.0, or a range including any two of the disclosed numerals. A non-limiting example of the range for z may be about 0.9-2, 1.0-1.8, or 1.2-1.7. z may be 0.9≤z≤2, 0.9<z<2, 0.09≤z<2, or 0.9<z≤2.

In formula (Ib), δ is any number between 0 and 0.25, optionally including a fractional part such as decimals and/or hundredths and denotes oxygen vacancies. δ may be any number between 0 and 0.25 including tenths, hundredths, or both. δ may be 0.0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, or 0.25. δ may be a range including any number named above while excluding at least one number mentioned above. For example, δ may equal 0.01 to 0.25. In an alternative example, δ may include one or more ranges of 0.01 to 0.25, 0.10 to 0.23, or 0.15 to 0.20.

In one or more embodiments, the oxygen vacancies within the conducting oxide may contribute to beneficial properties of the material. Thus, the oxygen vacancies are formed and preserved on purpose, and processes which would eliminate presence of oxygen vacancies may be avoided or excluded during the material synthesis and/or use.

Oxygen vacancies in the conducting oxide may be characterized as a quantitatively smaller amount of oxygen atoms present in the material than expected in the parent material's structure. Oxygen vacancies are typically formed by removing an oxygen from a compound of oxygen, for example by annealing in a reducing atmosphere of N₂, Ar, or the like. In another embodiment, annealing may be carried out in a vacuum furnace. The oxygen vacancies may render the material non-stoichiometric or deviating from stoichiometry such that the elemental composition of the material may not be represented by a ratio of well-defined natural numbers. The material; however, may be stoichiometric.

In some applications, oxygen vacancies may be perceived as undesirable defects influencing structural, electrical, optical, dissociative and reductive properties, or other properties in a manner which is not suitable for various applications. In contrast, the materials disclosed herein may have desirable properties due to oxygen vacancies being present. While a base or parent compound and a material with oxygen vacancies may have common morphology, structure, or lattice to a certain degree, their properties may significantly differ. For example, the oxide's lattice may include extra bonds or lack bonds in spaces where the paternal phase without the oxygen vacancy would include a bond.

Non-limiting examples of binary oxides of formulas (I), (Ia), may include one or more compositions listed in Tables 2 and 3 listed in the Experimental section. Non-limiting example binary oxides may include C_{0.1}Zn_{0.9}O, F_{0.1}Ti_{0.9}O₂, CdSb₂O₃, Li_{0.1}Zn_{0.9}O, K_{0.1}Zn_{0.9}O, Na_{0.1}Zn_{0.9}O, Ta_{0.1}Zn_{0.9}O, C_{0.1}Zn_{0.9}O, or Na_{0.1}Cd_{0.9}O.

Non-limiting examples of ternary oxides of formulas (I), (Ia), may include one or more compositions listed in Tables 2 and 3 listed in the Experimental section. Non-limiting example ternary oxides may include Si_{0.1}Cd_{0.9}Sb₂O₃, Nb_{0.1}Cd_{0.9}Sb₂O₃, Sn_{0.1}Cd_{0.9}Sb₂O₃, Ti_{0.1}Cd_{0.9}Sb₂O₃, B_{0.1}Cd_{0.9}Sb₂O₃, Ba_{0.1}Cd_{0.9}Sb₂O₃, Zr_{0.1}Cd_{0.9}Sb₂O, Cr_{0.1}Cd_{0.9}Sb₂O, V_{0.1}Cd_{0.9}Sb₂O, Sr_{0.1}Cd_{0.9}Sb₂O, or Cl_{0.1}Cd_{0.9}Sb₂O₃.

Non-limiting examples of binary and ternary oxides of formula (Ib), may include one or more compositions listed in Table 2 and 3 with added oxygen vacancy. In a non-limiting example, Ti_{0.9}FO₂ may have oxygen vacancies and become Ti_{0.9}FO_{1.99}.

The material may further expressly exclude one or more compositions such as TiO₂, FTO, or the like. Additional compounds named herein or defined by the formulas named herein may be expressly excluded.

Additionally, or in the alternative, the material may include, comprise, consist essentially of, or consist of one or more compositions of formula (II):

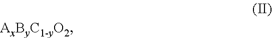

where
A is a halogen,
B is Sn or Zn,
C is Ti or Cd,
x is any number between 0.01 and 0.2, and
y is any number between 0 and 1.

The material may include one or more metal oxides having about 0-25 at. % oxygen vacancies compared to the stoichiometric ideals. The material may include, comprise, consist essentially of, or consist of one or more compositions, featuring an oxygen vacancy, of formula (IIa):

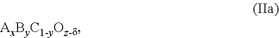

where
A is a halogen,
B is Sn or Zn,
C is Ti or Cd,
x is any number between 0.01 and 0.2,
y is any number between 0 and 1,
z is any number between 0.9 and 3, and
δ is any number between 0 and 0.25, optionally including a fractional part corresponding to the oxygen vacancies.

In formulas (II), (IIa), A may be a halogen from the VIII. A group of the Periodic Table of Elements. A may be an element from Period 2 of the Periodic Table of Elements and may include F; Period 3 and include Cl; Period 4 and include Br, or Period 5 and include I. A may be an element selected from the group consisting of F, Cl, Br, or I.

In formulas (II), (IIa), x may be any number between about 0.01 and 0.2. x may be about 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.10, 0.105, 0.11, 0.115, 0.12, 0.125, 0.13, 0.135, 0.14, 0.145, 0.15, 0.155, 0.16, 0.165, 0.17, 0.175, 0.18, 0.185, 0.19, 0.195, or 0.20, or a range including any two of the disclosed numerals. A non-limiting example of the range may be about 0.01-0.2, 0.03-0.09, or 0.05-0.075. x may be 0.01≤x≤0.2, 0.01<x<0.2, 0.01≤x<0.2, or 0.01<x≤0.2.

In formulas (II), (IIa), y may be any number between about 0 and 1. y may be about 0, 0.05, 0.11, 0.115, 0.2, 0.25, 0.3, 0.35, 0.4, 0.45, 0.5, 0.55, 0.6, 0.65, 0.7, 0.75, 0.8, 0.85, 0.9, 0.95, or 1.0, or a range including any two of the disclosed numerals. A non-limiting example of the range for y may be about 0.0-1.0, 0.1-0.8, or 0.2-0.7. y may be 0.0≤y≤1.0, 0.09<y<1.0, 0.0y≤1.0, or 0.0<y≤1.0.

In formulas (II), (IIa), z may be any number between about 0.9 and 3. z may be about 0.9, 0.95, 1.0, 1.05, 1.11, 1.115, 1.2, 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, or 3.0, or a range including any two of the disclosed numerals. A non-limiting example of the range for z may be about 0.9-2, 1.0-1.8, or 1.2-1.7. z may be 0.9≤z≤2, 0.9<z<2, 0.09≤z<2, or 0.9<z≤2.

In formula (IIa), δ is any number between 0 and 0.25, optionally including a fractional part such as decimals and/or hundredths and denotes oxygen vacancies. δ may be any number between 0 and 0.25 including tenths, hundredths, or both. δ may be 0.0, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, or 0.25. δ may be a range including any number named above while excluding at least one number mentioned above. For example, δ may equal 0.01 to 0.25. In an alternative example, δ may include one or more ranges of 0.01 to 0.25, 0.10 to 0.23, or 0.15 to 0.20.

In one or more embodiments, the material may include one or more compositions of formulas (I), (Ia), (Ib), (II), and/or (IIa). In one or more embodiments, a catalyst support may include one composition, at least one composition, or more than one composition of the material of formula (I) and one composition, at least one composition, or more than one composition of the material of formula (II). In at least one embodiment, the material may include at least one conducting oxide having the formula (Ib) or (IIa). The material may form a stabilizing layer which has good adhesion to a substrate and the catalyst. The material may minimize or eliminate catalyst particle detachment. The material may thus enable lower loading of catalyst particles on the electrode because the material is structured to retain the catalyst particles in place.

The material may be produced as a powder, which may be applied by sintering to form a metal oxide powder. The applying may include powder coating. The powder coating may include plasma processing, electrostatically with curing under heat or UV light, or the like. The powder may be processed at a relatively high vacuum or high temperature to prevent over oxidation. The powder may be annealed at elevated temperature above about 100° C. to reduce the number of defects. Alternatively, if oxygen vacancies are desired, annealing described above may be utilized.

The powder material may be mixed with binders and other conductive materials such as carbon black for enhanced electron conductivity, an ionomer for enhanced proton conductivity, etc., into a slurry. The slurry may be applied as a catalyst support layer. The applying may include dropcasting or another method.

The mixture may be applied as a coating on a flow field plate. The application may be vapor deposition such as atomic layer deposition (ALD), solution deposition such as electroplating, or the like. A screen may be used over a component, the coating may be deposited and etched away using the screen. The coating may be partially applied by etching away regular intervals of the coating. The coating may be annealed at an elevated temperature above about 100° C. to reduce the number of defects. If oxygen vacancies are desired, the application and/or formation method may differ and may include methods described above.

An electrocatalyst may be deposited on the metal oxide support disclosed herein by solution deposition, physical vapor deposition, chemical vapor deposition, atomic layer deposition, or solution-based approach, etc.

### EXPERIMENTAL SECTION

Data-driven materials screening was used to identify support materials that can be used in PEME electrodes. Several search criteria were set for selecting a catalyst support: 1) stability in water and in acidic media; 2) interface stability with Ir and IrNi such that the support may form a stable interface with Ni and Ir, reflected as a strong reaction with Ir and Ni; and 3) conductivity.

Density functional theory (DFT), which solves a system of electronic interactions for the ground-state energy of a material, was used to screen large classes of materials for the ground-state energy of materials to compute total energies of materials. Open materials database, materialsproject.org (MP) was utilized, allowing screening of large classes of materials. The energies database was used to screen the materials based on the following concepts: (a) total energy, (b) convex-hull decomposition, and (c) chemical potential.
(a) Total energy of a computed structure (typically in eV/atom or eV) describes the computed energy of a structure; the differences between structures correspond to a reaction energy between those structures. For example, the reaction A→B has a reaction energy E_{B}−E_{A} (where the energies might be written in kJ/mol).
(b) The convex hull of all stable compositions can be constructed such that each chemical composition C has a minimum combination of stable states, C→A+B, where the stoichiometric formula of C is equal to the sum of A and B, and there is no other A′+B′ that has a lower energy. Then A+B is the convex-hull decomposition products of C. If the energy of C is known, then the hull energy or decomposition energy (typically eV/atom or eV) is Eₕ=E_{c}−E_{A}−E_{B} and is always a nonnegative number. In some conventions it is reported as the reaction energy Eᵣₓₙ=E_{A}+E_{B}−E_{c} and is always a nonpositive number.
(c) Chemical potential (also typically in eV/atom or eV) describes the energy of an element whose stoichiometry is not balanced during a reaction. Physically it typically is used of oxygen or hydrogen, corresponding to an oxidative or reductive environment. It can also be used as a proxy for temperature because high temperatures can accelerate oxidation.

The following properties of the screened materials were computed and/or considered:
(d) Stability at a fixed temperature which was indicated by the hull energy. If it is less than the temperature (times the Boltzmann constant k_{B}), then the material was stable. Alternatively, it can be computed by the oxygen chemical potential which can be benchmarked to temperature at a known scale.
(e) Atom size, oxidation state, metal-oxygen ratio, crystal structure, spacegroup, elements, etc.
(f) Elemental material cost, per mol or per kg.
(g) Reactivity screening, which is the likelihood of a reactivity between the composition C and a reactant R. Using the convex-hull methodology, the reactivity was computed by examining (1) the decomposition products of a composition C+xR and (2) the relative decomposition energy of ε(x)=E(C+xR)−E(C)−xE(R) (a nonpositive number). The most stable reaction is the one that has the minimum e, while the dilute limit is the lowest value of x that has a nonzero ε.

The reactivity may be benchmarked to some known material C′ using the following two quantities: At which molar fraction x does the reaction occur? A higher reactivity is associated with a higher value of x, i.e. more of the reaction occurs per molar unit of C (or C′). A typical metric may be: RR_{stoich}=x_{C}/x_{C′}, where C′ is the reference material and RR stands for the relative reactivity.

What is the relative decomposition energy ε? A higher reactivity is associated with a lower value of ε (higher absolute value), i.e. the reaction is more energetically favorable. A typical metric may be: RRₑₙ=ε_{C}/ε_{C′}, where C′ is the reference material. It may also be: RRₑₙ=(ε_{C′}−ε_{C})/k_{B}T, where k_{B} is the Boltzmann constant and T is the absolute temperature.

379 materials were screened. Focus was on transparent conducting oxides (TCO's) with various dopants. Non-limiting example screened materials, their most stable (MS) reaction, the most stable reactant ratio, and reaction energy are shown in Table 1. The reference material C′ was set as F_{0.1}Sn_{0.9}O₂ or fluorine-doped tin oxide (FTO). FTO was chosen as a known TCO.

TABLE 1
Reaction screening results for non-limiting example screened materials

| | | | MS reactant | MS reaction |
|---|---|---|---|---|
| Reactant | Composition | MS reaction | ratio [wt] | energy [eV/at] |
| H₂O | TiO₂ | No reactions found | 0.000 | 0.000 |
| H | TiO₂ | No reactions found | 0.000 | 0.000 |
| Ni | TiO₂ | No reactions found | 0.000 | 0.000 |
| Ir | TiO₂ | No reactions found | 0.000 | 0.000 |
| H₂O | Zn_{0.9}O_{1.1} | 0.4737 H₂O + 0.5263 Zn_{0.9}O_{1.1} −> | 0.212 | −0.002 |
| | | 0.4737 Zn(HO)₂ + 0.05263 O₂ | | |
| H | Zn_{0.9}O_{1.1} | 0.1429 H₂ + 0.7143 Zn_{0.9}O_{1.1} −> | 0.005 | −0.321 |
| | | 0.1429 Zn(HO)₂ + 0.5 ZnO | | |
| Ni | Zn_{0.9}O_{1.1} | 0.8333 Zn_{0.9}O_{1.1} + 0.1667 Ni −> | 0.154 | −0.221 |
| | | 0.1667 NiO + 0.75 ZnO | | |
| Ir | Zn_{0.9}O_{1.1} | 0.9091 Zn_{0.9}O_{1.1} + 0.09091 Ir −> | 0.251 | −0.18 |
| | | 0.09091 IrO₂ + 0.8182 ZnO | | |
| H₂O | Sn_{0.9}O₂F_{0.1} | 0.8696 Sn_{0.9}O₂F_{0.1} + 0.1304 H2O −> | 0.019 | −0.003 |
| | | 0.08696 H₃OF + 0.7826 SnO₂ + 0.1087 O₂ | | |
| H | Sn_{0.9}O₂F_{0.1} | 0.303 Sn_{0.9}O₂F_{0.1} + 0.3485 H₂ −> | 0.016 | −0.323 |
| | | 0.2424 SnO + 0.01515 Sn₂OF₂ + 0.3485 H₂O | | |
| Ni | Sn_{0.9}O₂F_{0.1} | 0.8 Sn_{0.9}O₂F_{0.1} + 0.2 Ni −> | 0.104 | −0.201 |
| | | 0.04 NiF₂ + 0.16 NiO + 0.72 SnO₂ | | |
| Ir | Sn_{0.9}O₂F_{0.1} | 0.885 Sn_{0.9}O₂F_{0.1} + 0.115 Ir −> | 0.178 | −0.153 |
| | | 0.0177 Sn₂OF₅ + 0.7611 SnO₂ + 0.115 IrO₂ | | |

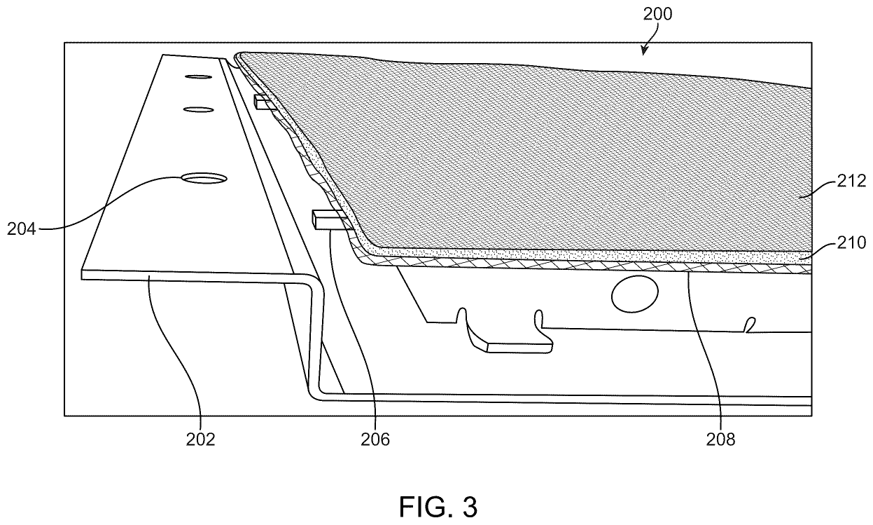

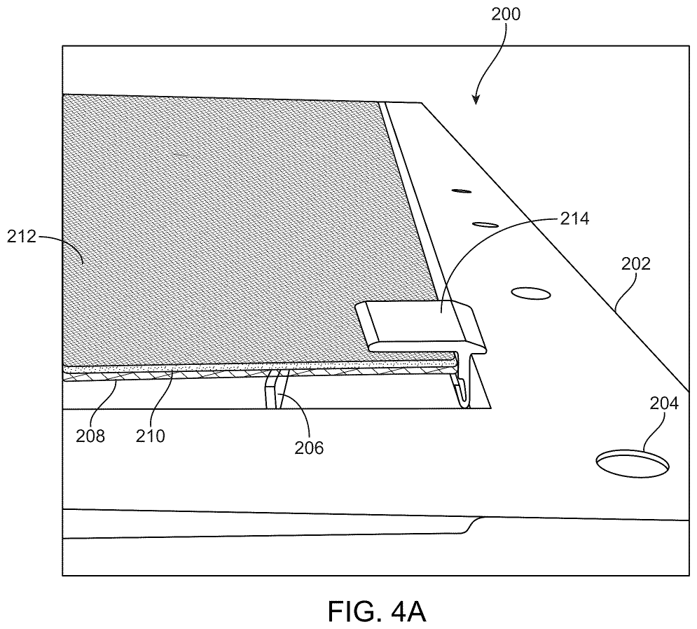

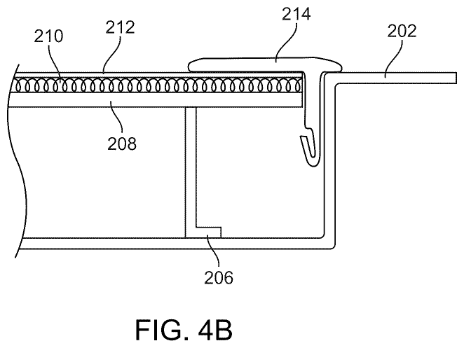

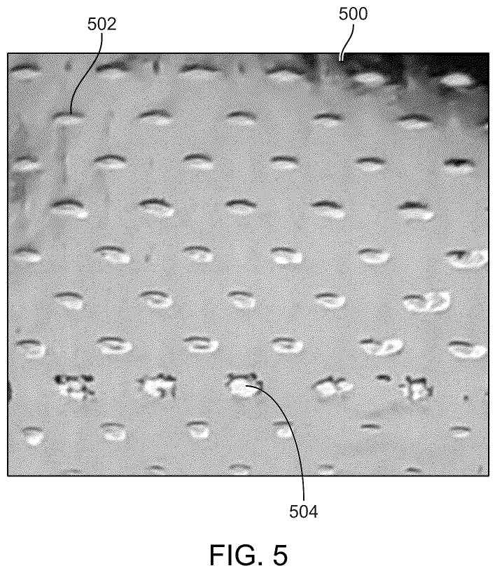

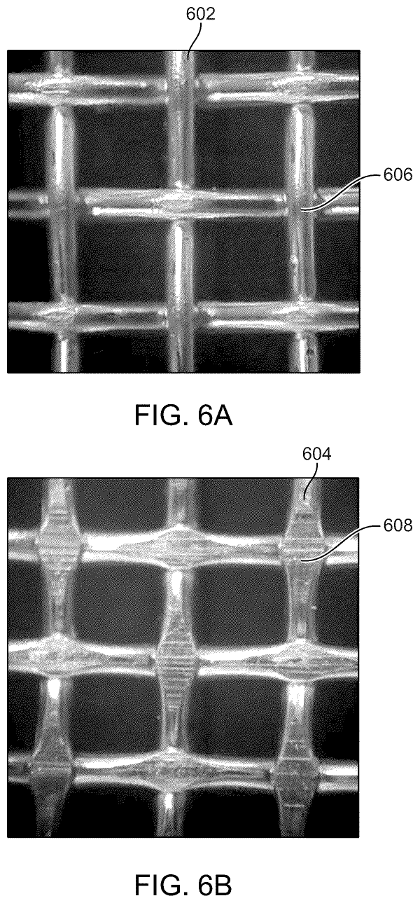

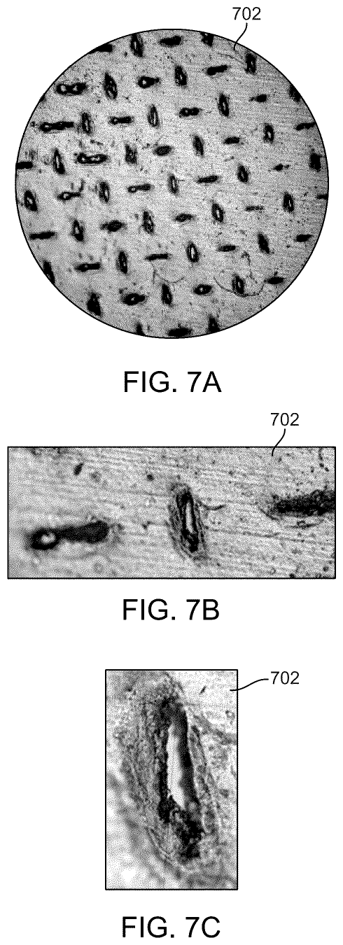

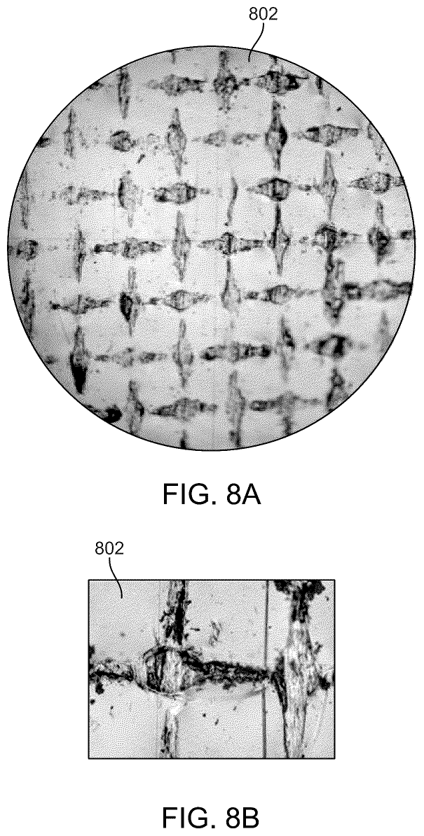

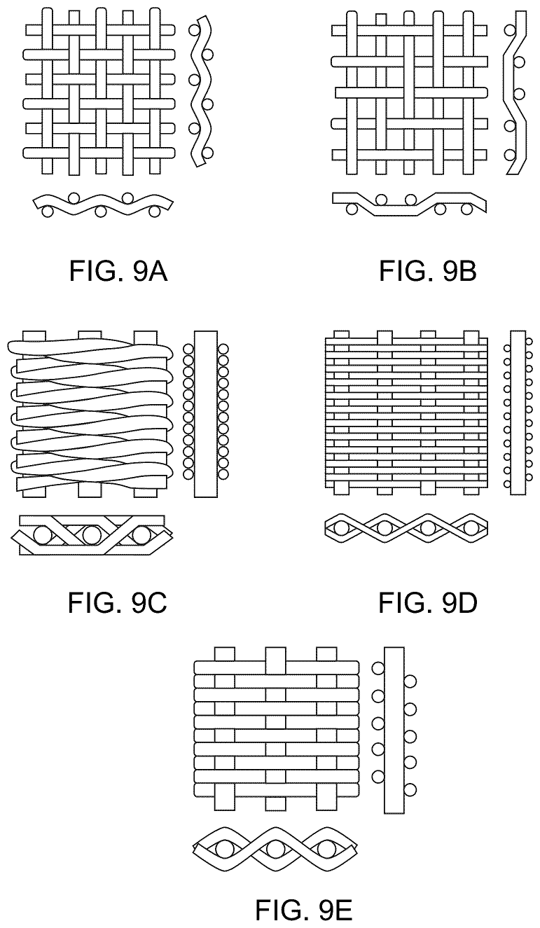

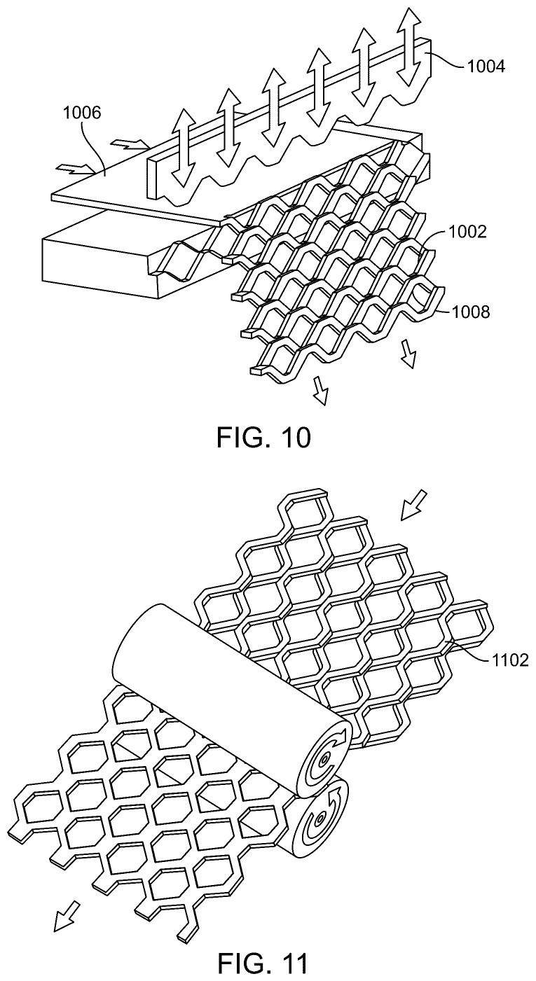

FIG. 3 shows the results of the reactivity screening relative to a reference material F_{0.1}Sn_{0.9}O₂ or FTO. In the plot of FIG. 3, the x axis relates to weighed reactivity 0 or resistance to reactions to H and water. Ideally, the resistance should be good and thus the desirable value is a high number. The y axis relates weighed reactivity of 1 or reactivity to Ni and Ir. The material should bind to Ni and Ir to prevent catalyst detachment. The desirable value should thus be high. FIG. 3 also conveys the current cost of the screened materials, which may serve as one of the criteria. The darker the color, the lesser cost per kg of material.

As can be seen in FIG. 3, some of the previously known and used materials may not have optimal properties. For example, TiO₂ is located in the lower right corner of the plot with low cost and good resistance to H and water reactions, but also with high resistance to Ni and Ir, which is undesirable. On the other hand, superoxides such as Zn_{0.9}O_{1.1} have high reactivity with H and water and high reactivity with Ni and Ir. High reactivity with all the studied species it not optimal either. F_{0.1}Sn_{0.9}O₂ has good reactivity with Ni and Ir, but its stability as a support material with respect to H and water, is not optimal. Therefore, the desirable materials may be located towards the upper right corner of the plot.

The materials were further screened for reactivity with H and water comparable to or better performing than the FTO (≥−2) and having at least equal or better reactivity with Ni and Ir as FTO (1). A shortlist of top candidate materials emerged from the plot and the secondary screening. The results are shown in Tables 2 and 3. The reference material F_{0.1}Sn_{0.9}O is marked in Italics.

TABLE 2
Top candidate materials based on the reactivity screening

| | Resistance to | Adherence to | |
|---|---|---|---|
| Composition | H and H₂O | Ir and Ni | Cost per kg |
| Cl_{0.1}Zn_{0.9}O | −0.232 | 0.239 | 2.436 |
| F_{0.1}Ti_{0.9}O₂ | −0.655 | 1.349 | 56.399 |
| F_{0.1}Sn_{0.9}O₂ | −2.000 | 1.000 | 52.673 |
| Si_{0.1}Cd_{0.9}Sb₂O₃ | 0.080 | −0.460 | 9.886 |
| Nb_{0.1}Cd_{0.9}Sb₂O₃ | −0.155 | −0.407 | 10.251 |
| Sn_{0.1}Cd_{0.9}Sb₂O₃ | −0.189 | −0.456 | 10.672 |
| Ti_{0.1}Cd_{0.9}Sb₂O₃ | −0.194 | −0.433 | 10.003 |
| B_{0.1}Cd_{0.9}Sb₂O₃ | −0.222 | −0.469 | 9.92 |
| Ba_{0.1}Cd_{0.9}Sb₂O₃ | −0.299 | −0.531 | 9.618 |
| Zr_{0.1}Cd_{0.9}Sb₂O₃ | −0.331 | −0.445 | 9.78 |
| Cr_{0.1}Cd_{0.9}Sb₂O₃ | −0.343 | −0.473 | 9.85 |
| V_{0.1}Cd_{0.9}Sb₂O₃ | −0.351 | −0.473 | 10.159 |
| Sr_{0.1}Cd_{0.9}Sb₂O₃ | −0.403 | −0.541 | 9.753 |
| Ca_{0.1}Cd_{0.9}Sb₂O₃ | −0.434 | −0.510 | 9.894 |
| C_{0.1}Cd_{0.9}Sb₂O₃ | −0.440 | −0.425 | 9.988 |
| Mn_{0.1}Cd_{0.9}Sb₂O₃ | −0.465 | −0.583 | 9.828 |
| Mg_{0.1}Cd_{0.9} Sb₂O₃ | −0.476 | −0.626 | 9.915 |
| Al_{0.1}Cd_{0.9}Sb₂O₃ | −0.513 | −0.468 | 9.894 |
| Be_{0.1}Cd_{0.9}Sb₂O₃ | −0.518 | −0.503 | 10.948 |
| As_{0.1}Cd_{0.9}Sb₂O₃ | −0.522 | −0.349 | 9.771 |
| Sb_{0.1}Cd_{0.9}Sb₂O₃ | −0.536 | −0.414 | 10.076 |
| H_{0.1}Cd_{0.9}Sb₂O₃ | −0.540 | −0.538 | 9.943 |
| Mo_{0.1}Cd_{0.9}Sb₂O₃ | −0.547 | −0.25 | 10.521 |
| Pb_{0.1}Cd_{0.9}Sb₂O₃ | −0.555 | −0.543 | 9.582 |
| S_{0.1}Cd_{0.9}Sb₂O₃ | −0.559 | −0.635 | 9.866 |
| Bi_{0.1}Cd_{0.9}Sb₂O₃ | −0.569 | −0.507 | 10.722 |
| Li_{0.1}Cd_{0.9}Sb₂O₃ | −0.580 | −0.558 | 9.935 |
| I_{0.1}Cd_{0.9}Sb₂O₃ | −0.592 | −0.647 | 10.826 |
| Br_{0.1}Cd_{0.9}Sb₂O₃ | −0.605 | −0.638 | 9.775 |
| Zn_{0.1}Cd_{0.9}Sb₂O₃ | −0.641 | −0.515 | 9.821 |
| Fe_{0.1}Cd_{0.9}Sb₂O₃ | −0.655 | −0.547 | 9.806 |
| Cl_{0.1}Cd_{0.9}Sb₂O₃ | −0.673 | −0.641 | 9.87 |
| Ar_{0.1}Cd_{0.9}Sb₂O₃ | −0.673 | −0.585 | 10.042 |
| Cu_{0.1}Cd_{0.9}Sb₂O₃ | −0.677 | −0.590 | 9.929 |
| He_{0.1}Cd_{0.9}Sb₂O₃ | −0.684 | −0.578 | 9.951 |
| CdSb₂O₃ | −0.769 | −0.528 | 9.745 |
| Cd_{0.9}Sb₂O_{3.1} | −0.843 | −0.655 | 9.917 |
| Ni_{0.1}Cd_{0.9}Sb₂O₃ | −0.854 | −0.755 | 10.136 |
| Co_{0.1}Cd_{0.9}Sb₂O₃ | −1.026 | −0.702 | 10.332 |
| N_{0.1}Cd_{0.9}Sb₂O₃ | −1.236 | −0.460 | 9.912 |

Additional materials when the Ir/Ni interface values were set slightly lower than 1 were identified and are shown in Table 3. The reference material F_{0.1}Sn_{0.9}O is marked in Italics.

TABLE 3
Additional candidate materials

| | Resistance to | Adherence to | |
|---|---|---|---|
| Composition | H and H₂O | Ir and Ni | Cost per kg |
| Li_{0.1}Zn_{0.9}O | 1.893 | −1.843 | 2.493 |
| K_{0.1}Zn_{0.9}O | 1.290 | −1.905 | 51.989 |
| Na_{0.1}Zn_{0.9}O | 1.175 | −1.848 | 9.855 |
| Ta_{0.1}Zn_{0.9}O | 0.735 | −1.679 | 67.396 |
| P_{0.1}Zn_{0.9}O | −0.055 | −1.551 | 14.3 |
| U_{0.1}Zn_{0.9}O | −0.128 | −1.628 | N/A |
| Cl_{0.1}Zn_{0.9}O | −0.232 | 0.239 | 2.436 |
| Nb_{0.1}Zn_{0.9}O | −0.573 | −1.664 | 4.767 |
| F_{0.1}Ti_{0.9}O₂ | −0.655 | 1.349 | 56.399 |
| W_{0.1}Zn_{0.9}O | −1.413 | −1.587 | 11.197 |
| F_{0.1}Sn_{0.9}O | −2.00 | 1.000 | 52.673 |
| Te_{0.1}Zn_{0.9}O | −2.036 | −1.614 | 52.938 |
| Na_{0.1}Cd_{0.9}O | −2.063 | −1.956 | 7.55 |
| Mo_{0.1}Zn_{0.9}O | −2.111 | −1.738 | 6.073 |
| Hg_{0.1}Zn_{0.9}O | −2.187 | −1.832 | 13.305 |
| Ag_{0.1}Zn_{0.9}O | −2.569 | −1.438 | 100.508 |
| Se_{0.1}Zn_{0.9}O | −2.593 | −1.168 | 16.172 |
| Au_{0.1}Zn_{0.9}O | −2.617 | −1.350 | 9455.467 |
| Pt_{0.1}Zn_{0.9}O | −2.646 | −1.825 | 10210.019 |
| I_{0.1}Zn_{0.9}O | −2.785 | −1.002 | 7.642 |
| H_{0.1}Zn_{0.9}O | −2.925 | −1.736 | 2.479 |
| Xe_{0.1}Zn_{0.9}O | −2.971 | −0.612 | 181.153 |
| Rh_{0.1}Zn_{0.9}O | −2.993 | −1.345 | 2411.038 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An electrolyzer catalyst support comprising:
a material including one or more conducting oxide compositions of formula (I): 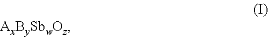
where
A is a dopant and is a halogen, alkali metal, transition metal, or metalloid,
B is Zn, Cd, Sn, or Ti,
x is any number between about 0.0 and 0.2,
y is any number between 0.9 and 2,
w is 0 or 2, and
z is any number between 0.9 and 3,
when A is F and B is Sn, the oxide is non-stoichiometric.

2. The electrolyzer catalyst support of claim 1, wherein the catalyst support is an anode electrocatalyst support.

3. The electrolyzer catalyst support of claim 1, wherein w is 0 such that the material includes a binary conducting oxide.

4. The electrolyzer catalyst support of claim 1, wherein A is F, Cl, Ta, or B.

5. The electrolyzer catalyst support of claim 1, wherein B is Cd.

6. The electrolyzer of claim 1, wherein at least one of the one or more conducting oxides of formula (I) have an oxygen vacancy.

7. The electrolyzer catalyst support of claim 1, wherein the material further includes a conducting oxide having a formula (II): 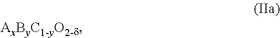
where
A is a halogen,
B is Sn or Zn,
C is Ti or Cd,
x is any number between 0.01 and 0.2,
y is any number between 0 and 1, and
δ is any number between 0 and 3 optionally including a fractional part denoting oxygen vacancies.

8. The electrolyzer catalyst support of claim 1, wherein the material includes CdSb₂O₃.

9. An electrochemical cell electrode comprising:
an electrocatalyst including Ir, Ru, or both; and
an electrocatalyst support adhered to the electrocatalyst and including a material having one or more conducting oxide compositions of formula (I): 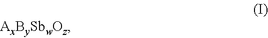
where
A is a dopant and is a halogen, alkali metal, transition metal, or metalloid,
B is Zn, Cd, or Ti,
x is any number between about 0.0 and 0.2,
y is any number between 0.9 and 2,
w is 0 or 2, and
z is any number between 0.9 and 3.

10. The electrochemical cell electrode of claim 9, wherein A is a halogen.

11. The electrochemical cell electrode of claim 9, wherein w is 0.

12. The electrochemical cell electrode of claim 9, wherein the material includes a ternary oxide and Sb is present.

13. The electrochemical cell electrode of claim 9, wherein the material further includes a conducting oxide having a formula (II): 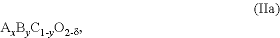
where
A is a halogen,
B is Sn or Zn,
C is Ti or Cd,
x is any number between 0.01 and 0.2,
y is any number between 0 and 1, and
δ is any number between 0 and 3 optionally including a fractional part denoting oxygen vacancies.

14. The electrochemical cell electrode of claim 9, wherein the electrochemical cell is an electrolyzer.

15. The electrochemical cell electrode of claim 9, wherein the electrocatalyst has a formula IrₓNi₁₋ₓ, where 0≤x≤1.

16. An electrochemical cell component comprising:
a bulk layer including metal; and
a surface layer including a conducting oxide material including one or more compositions of formula (I): 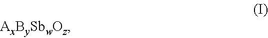
where
A is a dopant and is a halogen, alkali metal, transition metal, or metalloid,
B is Zn, Cd, Sn, or Ti,
x is any number between about 0.0 and 0.2,
y is any number between 0.9 and 2,
w is 0 or 2, and
z is any number between 0.9 and 3,
when A is F and B is Sn, w=0, z=2, and the composition further includes Ti_{1-y}.

17. The electrochemical cell component of claim 16, wherein the component is an anode electrocatalyst support.

18. The electrochemical cell component of claim 16, wherein the component is a flow field plate.

19. The electrochemical cell component of claim 16, wherein the conducting oxide material includes a binary zinc oxide.

20. The electrochemical cell component of claim 16, wherein A is Cl, Ta, or B.
